(19) United States
(12) Patent Application Publication
(10) Pub. No.: US 2014/0062146 A1
(43) Pub. Date: Mar. 6, 2014

(54) FOLDABLE STROLLER CAPABLE OF FOLDING A SEATBACK AUTOMATICALLY

(71) Applicants: Robert E. Haut, West Chester, PA (US); Andrew James Taylor, Mohnton, PA (US)

(72) Inventors: Robert E. Haut, West Chester, PA (US); Andrew James Taylor, Mohnton, PA (US)

(21) Appl. No.: 14/014,385

(22) Filed: Aug. 30, 2013

Related U.S. Application Data
(60) Provisional application No. 61/743,336, filed on Aug. 31, 2012.

(51) Int. Cl. B62B 9/20; B62B 7/00

(52) U.S. Cl. CPC B62B 9/20; B62B 7/00
USPC 297/183.1

(57) ABSTRACT

A foldable stroller includes a frame body, a recline adjustment mechanism and a linking component. The frame body includes a seat, a push handle, an armrest, a front leg, a rear leg, and a seatback pivoted on the seat. An end of the armrest is pivoted on the push handle, and the other end of the armrest is pivoted on the front leg and the rear leg. The armrest, an upper portion of the front leg and an upper portion of the rear leg are formed as a lateral frame. The recline adjustment mechanism is for adjusting a reclined angle of the seatback. The linking component is connected between the seatback and the lateral frame, and the lateral frame rotates upwards relative to the push handle to move the linking component upwards, so as to drive the seatback to an upright position as folding the frame body.

### CROSS REFERENCE TO RELATED APPLICATIONS

This application claims the benefit of U.S. Provisional Application No. 61/743,336, filed on Aug. 31, 2012, the contents of which are incorporated herein in their entirety.

### BACKGROUND OF THE INVENTION

1. Field of the Invention

The present invention relates to a foldable stroller, and more specifically, to a foldable stroller capable of folding a seatback automatically.

2. Description of the Prior Art

Strollers provide a very convenient way to transport babies and children seated, standing, and as a travel system in a car seat. It is typically comprised of a tubular frame structure that supports a seat or a platform, and a seatback pivoted on a rear of the tubular frame structure, so that the seatback can rotate relative to the tubular frame structure to a most upright position, a most reclined position, or any position therebetween via a recline mechanism. There are two typical recline adjustment mechanisms. Please refer to FIG. 1 and FIG. 2. FIG. 1 is a partial diagram of a cord recline adjustment mechanism 10′ of a conventional foldable stroller in the prior art. FIG. 2 is a partial diagram of a mechanical recline adjustment mechanism 40′ of a conventional foldable stroller in the prior art. As shown in FIG. 1, the cord recline adjustment mechanism 10′ includes a cord 12′ and an adjuster 14′ for adjusting a length of the cord 12′. The cord 12′ is for connecting a seatback 20′ to a stroller frame 30′, and a reclined angle of the seatback 20′ relative to the stroller frame 30′ can be adjusted by adjusting the length of the cord 12′ with the adjuster 14′. As shown in FIG. 2, the mechanical recline adjustment mechanism 40′ includes a pin 42′ disposed on a bottom of the seatback 20′, and a plurality of notches 44′ disposed on the stroller frame 30′ for engaging with the pin 42′. A reclined angle of the seatback 20′ relative to the stroller frame 30′ can be adjusted by inserting the pin 42′ into different notches 44′.

For convenience, strollers are typically foldable, so that they can be stowed away while not in use or while being transported. Please refer to FIG. 1 to FIG. 4. FIG. 3 is a schematic drawing of a conventional foldable stroller 100′ in FIG. 1, as being folded, in the prior art. FIG. 4 is a schematic drawing of the conventional foldable stroller 100′ in FIG. 2, as being folded, in the prior art. The seatback 20′ is reclined backwardly relative to the stroller frame 30′ in a using status as shown in FIG. 1 and FIG. 2. After the foldable stroller 100′ is folded in a front-back direction, as shown in FIG. 3 and FIG. 4, the seatback 20′ still protrudes from a rear of the folded stroller frame 30′. That is, the foldable stroller 100′ cannot be folded to a compact status for convenient storage and transportation without operating the cord recline adjustment mechanism 10′ or the mechanical recline adjustment mechanism 40′ to recover the reclined seatback 20′ to the most upright position. It is inconvenient in operating the cord recline adjustment mechanism 10′ or the mechanical recline adjustment mechanism 40′ to recover the reclined seatback 20′ to the most upright position as folding the foldable stroller 100′ every time. Hence, there is a need to design a foldable stroller capable of folding the seatback automatically with a simple structure to solve above problems.

### SUMMARY OF THE INVENTION

A purpose of the present invention is to provide a foldable stroller capable of folding a seatback automatically with a simple structure, to solve the problems mentioned above.

In order to achieve above purposes, the present invention is to provide a foldable stroller including a frame body, a recline adjustment mechanism and a linking component. The frame body includes a seat, a push handle disposed on two sides of the seat, an armrest, a front leg, a rear leg and a seatback pivoted on the seat. An end of the armrest is pivoted on the push handle, and the other end of the armrest is pivoted on the front leg and the rear leg. The armrest, an upper portion of the front leg and an upper portion of the rear leg are formed as a lateral frame. The recline adjustment mechanism is fixed on the seat and connected to an end of the seatback for adjusting a reclined angle of the seatback. The linking component is connected between the seatback and the lateral frame, and the lateral frame rotates upwards relative to the push handle to move the linking component upwards so as to drive the seatback to an upright position as folding the frame body.

Preferably, the seatback is formed in a U-shape, the seatback comprises two lateral tubes connected to the recline adjustment mechanism, one end of the linking component is connected to the lateral tube, and the other end of the linking component is connected to the armrest.

As the frame body is folded, the armrest rotates upwards relative to the push handle, and the linking component connected to the armrest moves upwards, so as to pull the seatback upwards to be close to the push handle, for folding the seatback automatically.

Preferably, a lower end of the push handle and the rear leg are pivotally connected via a rack shaft.

Preferably, the linking component is made of flexible material. The flexible linking component does not interfere with the seatback, and the seatback can be located in a most upright position, a most reclined position, or any position therebetween.

Preferably, the flexible material is fabric, an injection molded plastic, or an elastic material.

Preferably, the recline adjustment mechanism comprises a rack fixed on the seat, and a latching component engaged with the rack and slidably connected to the end of the seatback.

Preferably, the end of the seatback and the rack are pivotally connected.

Preferably, the rack comprises a plurality of concentric arcs with different radii, the plurality of concentric arcs is stepped sequentially, and the radii of the plurality of concentric arcs are decreasing from back to front.

Preferably, the latching component comprises a sliding portion slidably connected to the seatback, an operating portion connected to the sliding portion, and a latching portion disposed on the sliding portion for engaging with or separating from the rack.

The frame body provides the convenience in the foldable stroller to be stowed away while not in use or while being transported, of the present invention. Furthermore, the recline adjustment mechanism disposed between the seatback and the seat can adjust the reclined angle of the seatback relative to the seat, so as to locate the seatback in the most upright position, the most reclined position, and any position therebetween, for providing users with more using conditions. Besides, the linking component connected between the seatback tube and the frame body can drive the seatback to rotate upwards without operating the recline adjustment mechanism again, so as to compact the foldable stroller as the frame body is folded. It has advantages of convenient operation and a simple structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partial diagram of a cord recline adjustment mechanism of a conventional foldable stroller in the prior art.

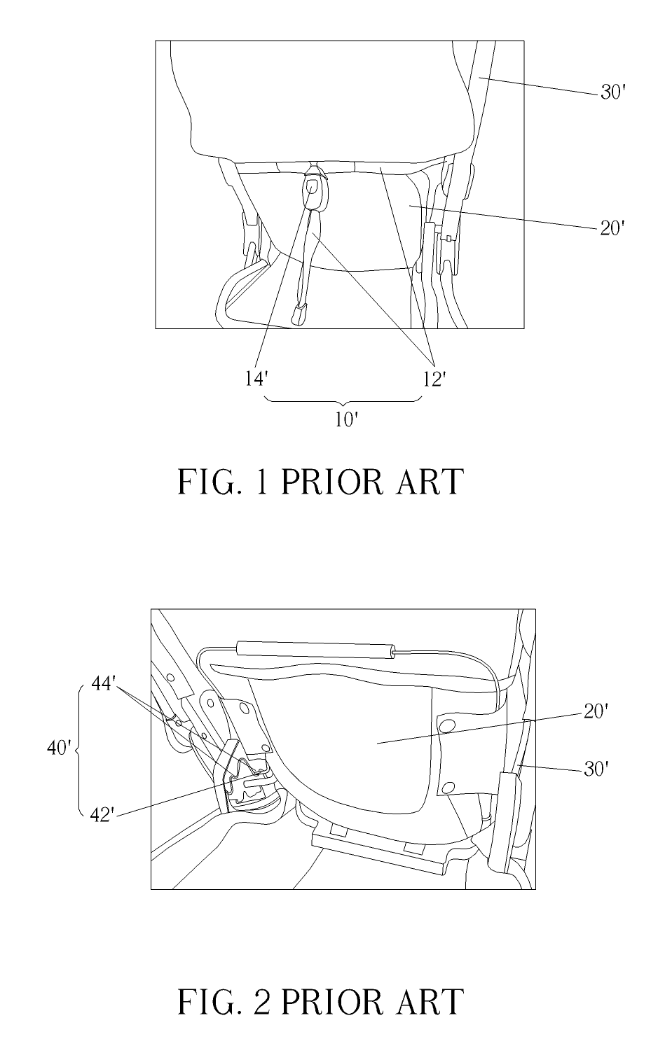

FIG. 2 is a partial diagram of a mechanical recline adjustment mechanism of a conventional foldable stroller in the prior art.

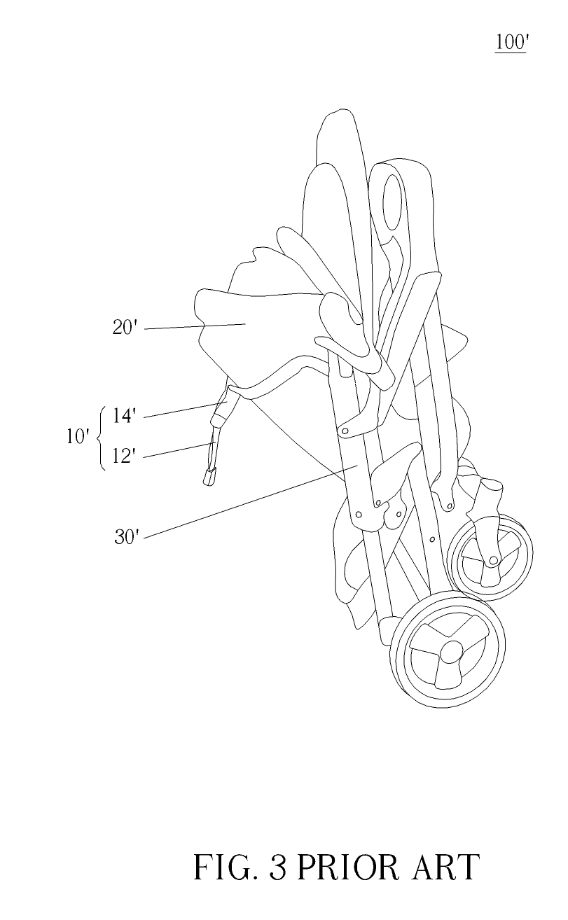

FIG. 3 is a schematic drawing of the conventional foldable stroller in FIG. 1, as being folded, in the prior art.

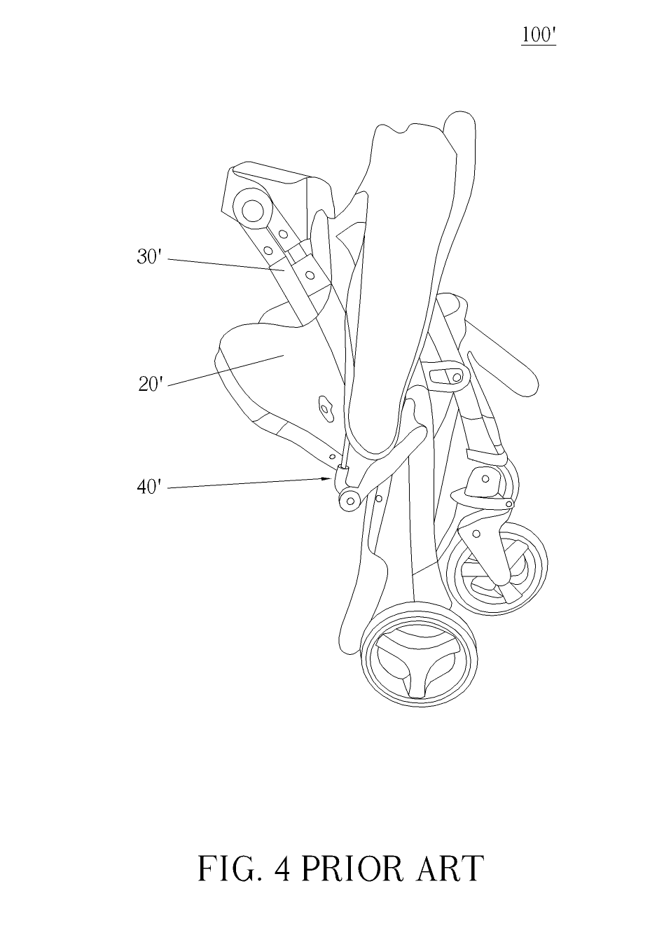

FIG. 4 is a schematic drawing of the conventional foldable stroller in FIG. 2, as being folded, in the prior art.

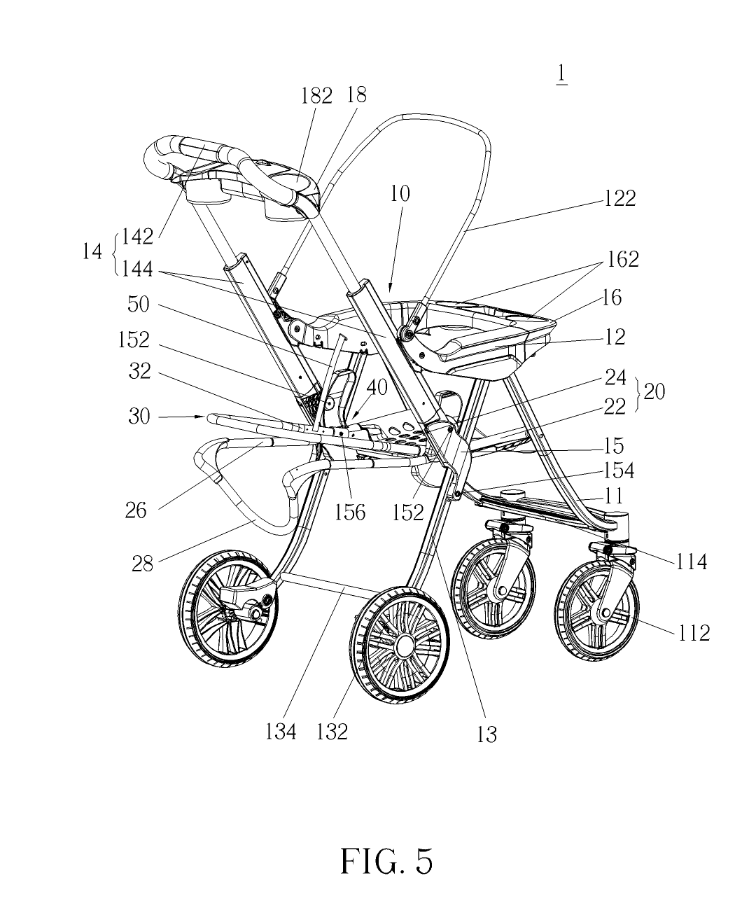

FIG. 5 to FIG. 7 are schematic drawings of a foldable stroller in different views and statuses according to an embodiment of the present invention.

FIG. 8 is a diagram of a rack according to the embodiment of the present invention.

FIG. 9 is a diagram of the rack and a latching component connected to a seatback tube shown in FIG. 5 according to the embodiment of the present invention.

FIG. 10 is a schematic drawing of the foldable stroller with a seatback in a reclined position according to the embodiment of the present invention.

FIG. 11 is a diagram of the rack and the latching component connected to the seatback tube shown in FIG. 10 according to the embodiment of the present invention.

FIG. 12 is a schematic drawing of the foldable stroller with the seatback in an upright position according to the embodiment of the present invention.

FIG. 13 is a diagram of the rack and the latching component connected to the seatback tube shown in FIG. 12 according to the embodiment of the present invention.

FIG. 14 is a diagram of the rack and the latching component connected to the seatback tube shown in FIG. 7 according to the embodiment of the present invention.

### DETAILED DESCRIPTION

In the following detailed description of the preferred embodiments, reference is made to the accompanying drawings which form a part hereof, and in which is shown by way of illustration specific embodiments in which the invention maybe practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. Accordingly, the drawings and descriptions will be regarded as illustrative in nature and not as restrictive.

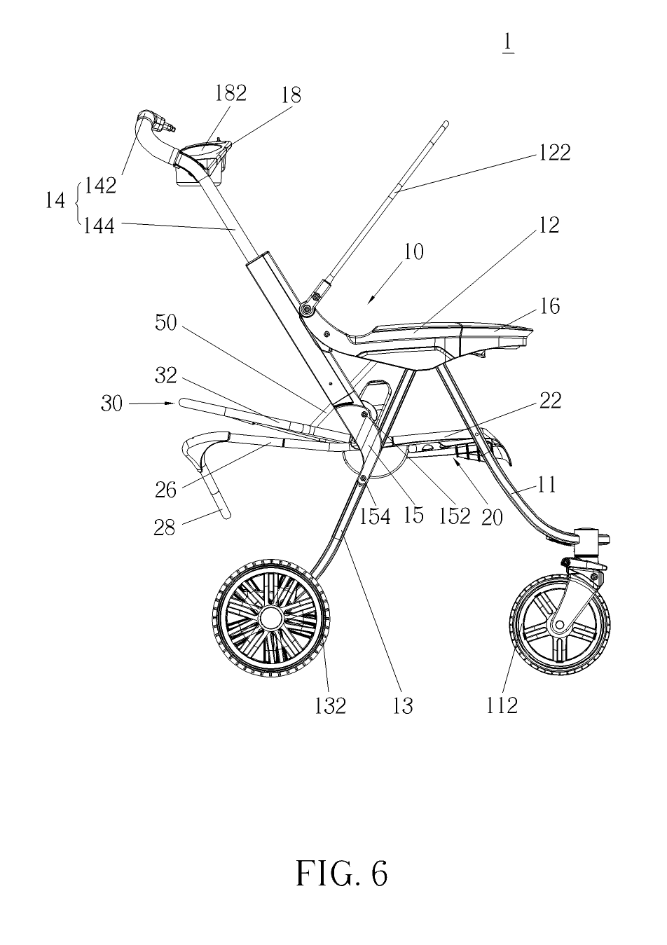

Please refer to FIG. 5 to FIG. 7. FIG. 5 to FIG. 7 are schematic drawings of a foldable stroller 1 in different views and statuses according to an embodiment of the present invention. The foldable stroller 1 is left-right symmetric. The foldable stroller 1 includes a frame body 10, which is foldable in a front-back direction. The frame body 10 includes a seat 20 whereon a baby sits, a push handle 14 disposed on two sides of the seat 20, at least one armrest 12, at least one front leg 11, at least one rear leg 13, and a seatback pivoted on the seat 20. A lower end of the seatback is pivoted on a rear end of the seat 20. An end of the armrest 12 is pivoted on the push handle 14. The other end of the armrest 12 is pivoted on the front leg 11 and the rear leg 13.

Specifically, the frame body 10 includes the two armrests 12 (left and right) and the push handle 14 formed in a U-shape. The push handle 14 includes two linking arms 144 and a crossbar 142 connected to upper ends of the two linking arms 144. Two rear ends of the two armrests 12 are pivotally connected to middle parts of the two linking arms 144, respectively. The armrests 12 can rotate upwards relative to the two linking arms 144 as the frame body 10 is folded. Preferably, the frame body 10 further includes a protecting component 16, and two ends of the protecting component 16 are respectively connected to front ends of the two armrests 12. The protecting component 16 can be formed in a U-shape as shown in FIG. 5, and a first containing space 162 is formed on the protecting component 16 for containing objects. The protecting component 16 can be detached from the two armrests 12 and replaced by a front armrest component (not shown in figures). The frame body 10 can further include a storage container 18 disposed on the push handle 14 and having a second containing space 182 with an upward opening for accommodating objects. Two ends of the storage container 18 are respectively connected to upper ends of the two linking arms 144. A canopy supporting tube 122 is pivoted on rear ends of the two armrests 12.

The frame body 10 includes a pair (left and right) of front legs 11, a pair (left and right) of rear legs 13, and a pair (left and right) of brackets 15 for pivotally connecting a lower end of the linking arm 144 to a middle part of the rear leg 13 at the same side. Upper ends of the front leg 11 and the rear leg 13 at the same side are pivotally connected to a front end of the corresponding armrest 12. A front wheel 112 is rotatably disposed on a lower end of each front leg 11, and a rear wheel 132 is rotatably disposed on a lower end of each rear leg 13. As shown in FIG. 5, a footrest 114 is disposed between the pair of front legs 11. Two ends of the footrest 114 are respectively connected to lower ends of the pair of front legs 11. A fixing rod 134 is disposed between the pair of rear legs 13. An upper end of the bracket 15 and the lower end of the corresponding linking arm 144 are rotatably connected via a first shaft 152. A lower end of the bracket 15 and the corresponding rear leg 13 are rotatably connected via a second shaft 154. As the foldable stroller 1 is folded, the linking arm 144 can rotate upwards around the first shaft 152.

The seat 20 includes two substantially parallel seat rods 22. A front end of the seat rod 22 is pivoted on a middle part of the corresponding front leg 11 at the same side. A rear end of the seat rod 22 is connected to a rear of the frame body 10, such as being connected to a lower end of the corresponding linking arm 144 or to the corresponding rear leg 13 at the same side. Specifically, the rear end of each seat rod 22 is pivoted on the lower end of the corresponding linking arm 144 via a rack 42. A seat board 24 is disposed between the two seat rods 22. The rear end of each seat rod 22 is connected to a first supporting tube 26. An extending direction of the first supporting tube 26 is substantially the same as an extending direction of the seat rod 22. A second supporting tube 28 is connected between rear ends of the two first supporting tubes 26, and the second supporting tube 28 is formed in a U-shape. A plane whereon the second supporting tube 28 is located is substantially perpendicular to a plane whereon the two first supporting tubes 26 are located. Therefore, as the foldable stroller 1 has been folded, the first supporting tubes 26 and the second supporting tube 28 can stand as supporting legs, as shown in FIG. 7. The first supporting tubes 26 and the second supporting tube 28 can support a basket for containing objects (not shown in figures). The basket can be made of fabric or plastic and have an upward opening. Two sides of the opening are fixed to the first supporting tubes 26, and the second supporting tube 28 supports a rear lateral wall of the basket.

Specifically, the seatback is pivotally connected to the rear of the frame body 10 or the rear of the seat 20. The seatback includes a seatback tube 30, and the seatback tube 30 is formed in a U-shape. The seatback further includes two lateral tubes 32. A lower end of each lateral tube 32 is rotatably connected to the rear of the seat 20 via a third shaft 156. The seatback tube 30 can be made of plastic or metal and for supporting the rear of the seat 20.

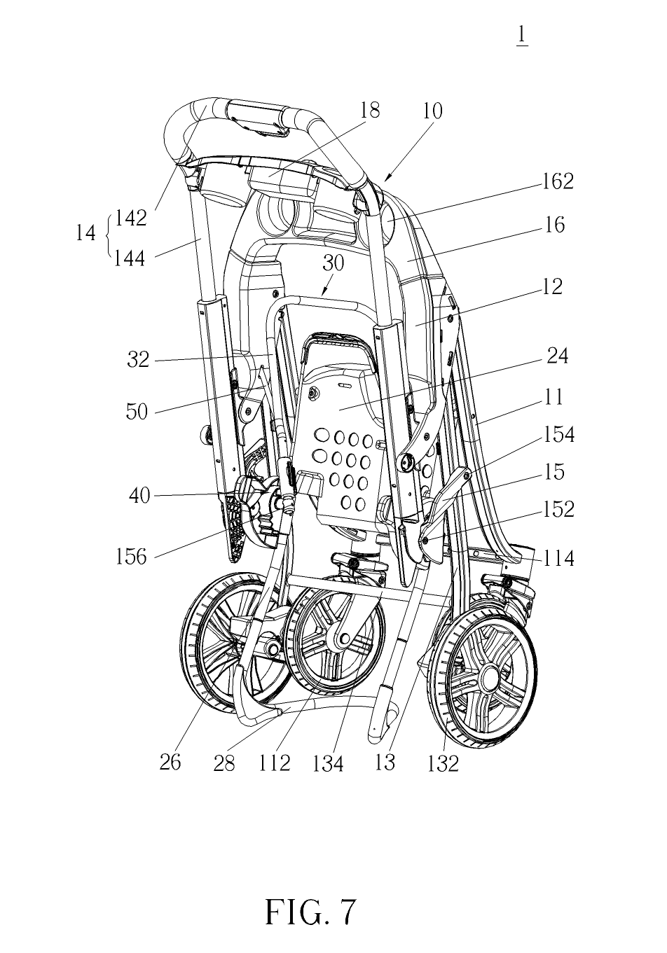

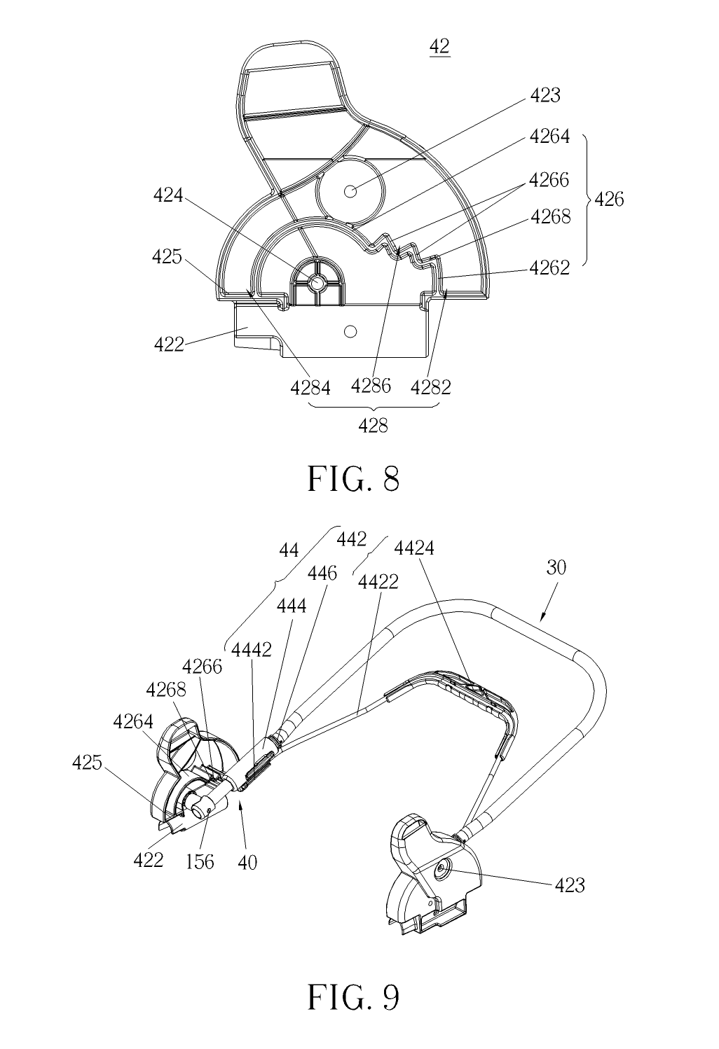

The foldable stroller 1 further includes a recline adjustment mechanism 40 disposed between the seatback tube 30 and the seat 20 for adjusting a reclined angle of the seatback tube 30, so that the seatback can rotate relative to the seat 20 to a most upright position, a most reclined position, or any position therebetween. Please refer to FIG. 5 to FIG. 9. FIG. 8 is a diagram of the rack 42 according to the embodiment of the present invention. FIG. 9 is a diagram of the rack 42 and a latching component 44 connected to the seatback tube 30 shown in FIG. 5 according to the embodiment of the present invention. The recline adjustment mechanism 40 includes the rack 42 fixed on the seat rods 22, and the latching component 44 engaged with the rack 42 and slidably connected to the seatback tube 30. The rack 42 includes a first hole 423 wherethrough the first shaft 152 passes, and a second hole 424 wherethrough the third shaft 156 passes. The first hole 423 and the second hole 424 are extended in a left-right direction of the foldable stroller 1. Two lower ends of the seatback tube 30 are respectively pivoted on the two racks 42 via the two third shafts 156. A sheathing tube 422 is disposed on a bottom of the rack 42. An extending direction of the sheathing tube 422 is substantially perpendicular to an extending direction of the second opening 424. The sheathing tube 422 sheathes the rear of the corresponding seat rod 22 for fixing the rack 40 with the seat rod 22. The rack 42 also can be formed with the seat rod 22 integrally.

The rack 40 further includes an engaging curved surface 426. The engaging curved surface 426 includes a plurality of concentric arcs with different radii about a center of the second hole 424. The plurality of concentric arcs is connected and stepped sequentially via platforms 4268. The engaging curved surface 426 is extended upwards from the rear of the second hole 424 to the front of the second hole 424. The radii of the plurality of concentric arcs are decreasing from back to front. That is, a radius of a first concentric arc 4262 in the back is the greatest, and a radius of a second concentric arc 4264 in the front is the smallest. Radii of third concentric arcs 4266 between the first concentric arc 4262 and the second concentric arc 4264 are increasing as being closer to the first concentric arc 4262. A first engaging slot 4282 is formed between the first concentric arc 4262 and a bottom plate 425 of the rack 42. A second engaging slot 4284 is formed between the second concentric arc 4264 and the bottom plate 425 of the rack 42. Third engaging slots 4286 are formed between the third concentric arcs 4266 and the adjacent platforms 4268, respectively. Since more third concentric arcs 4266 form more third engaging slots 4286, there will be more reclining positions to the seatback.

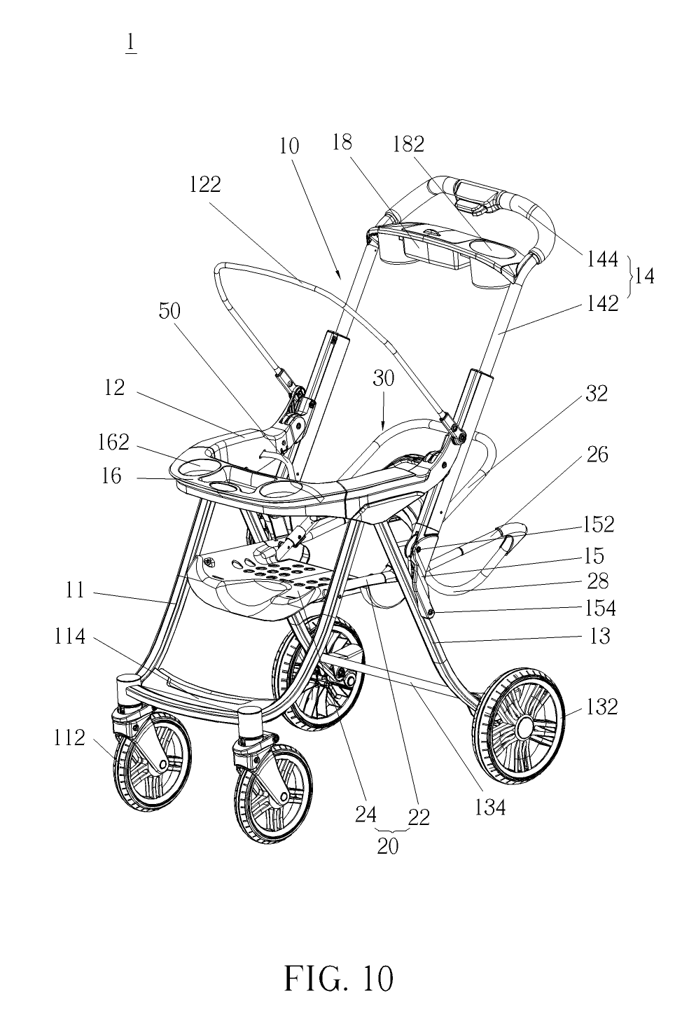

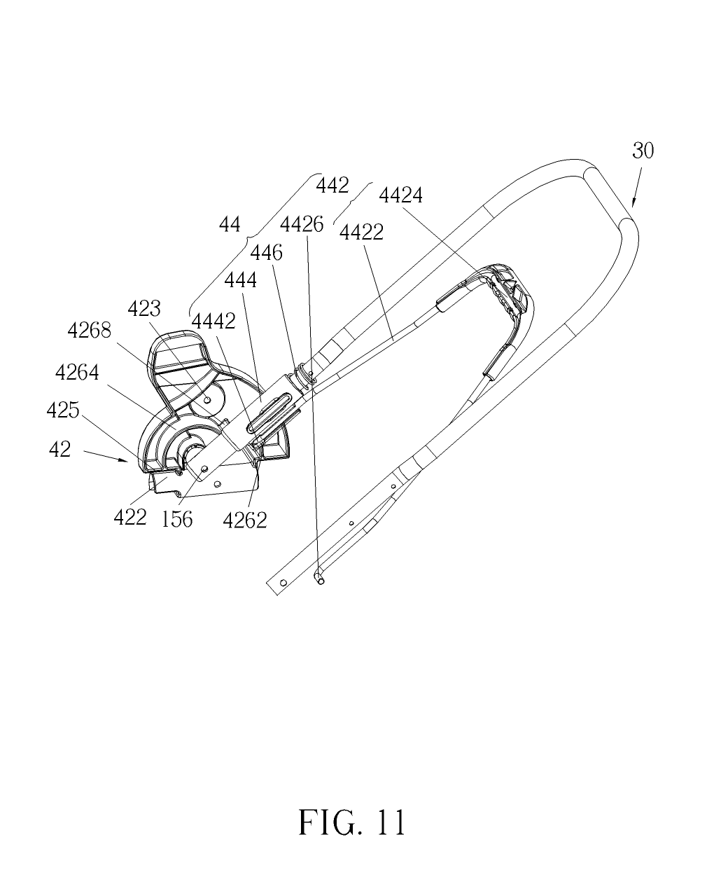

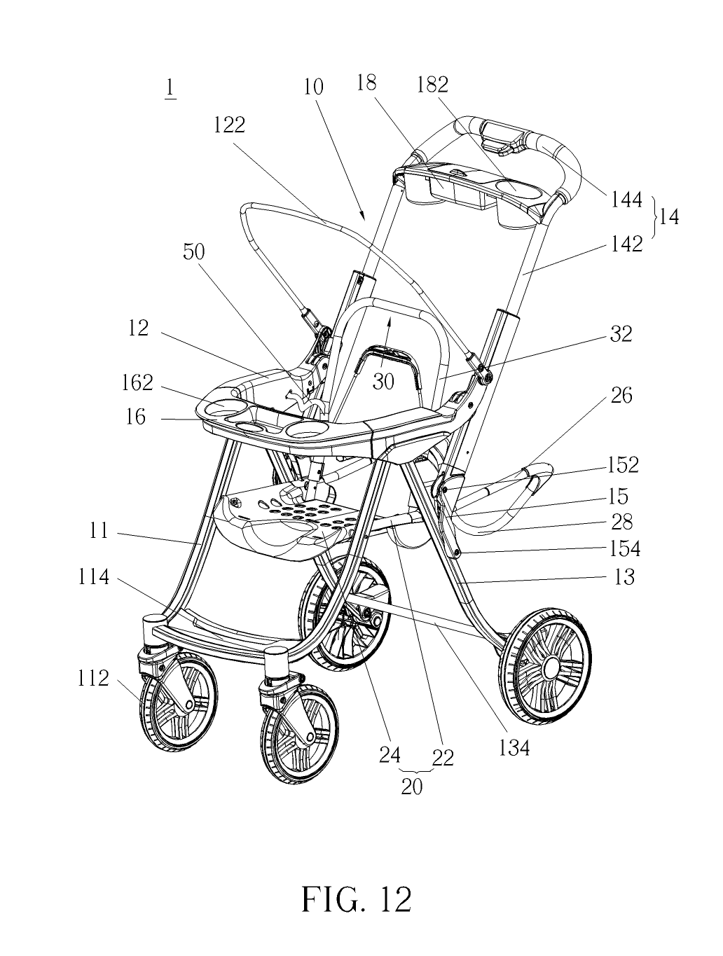

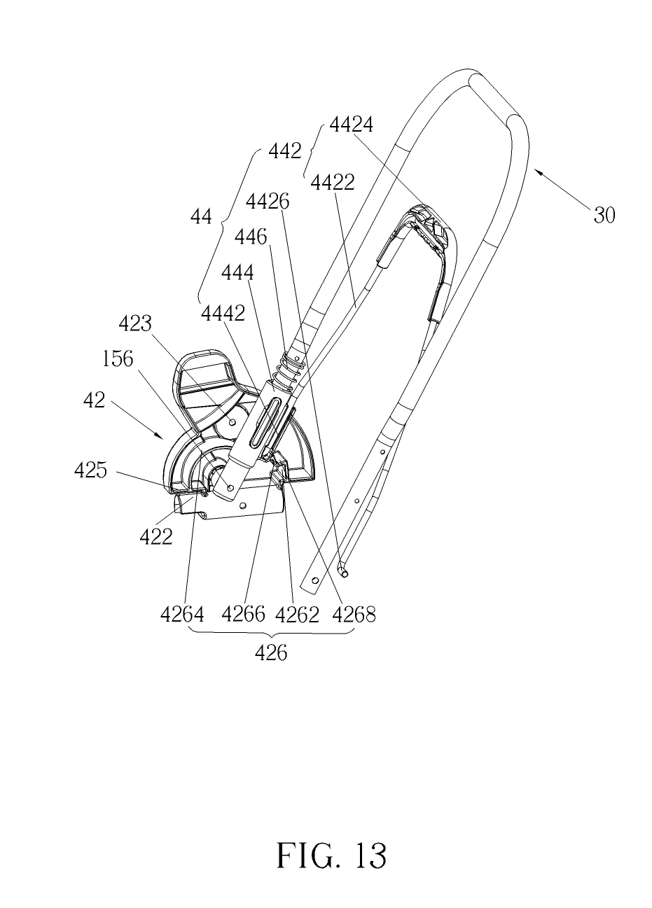

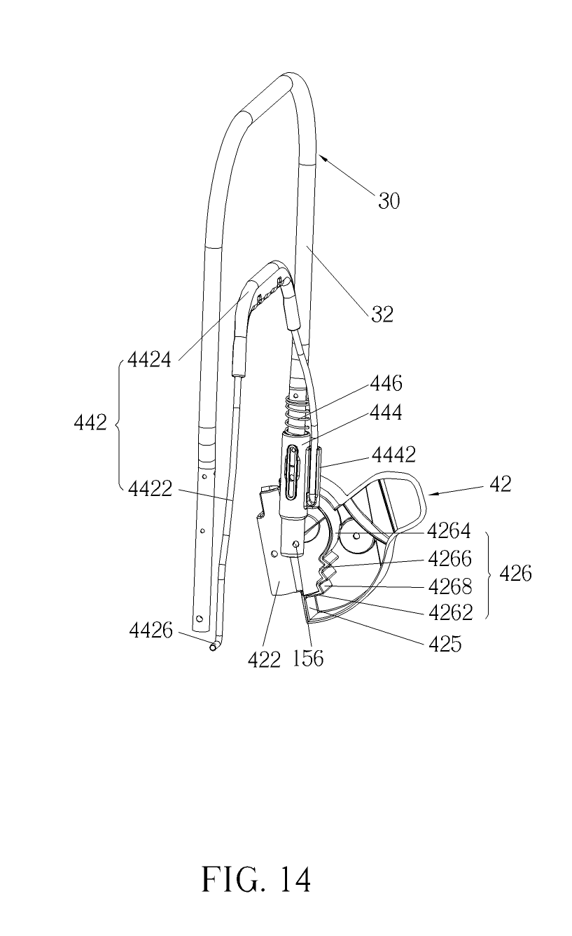

The latching component 44 includes at least one operating portion 442, at least one sliding portion 444, and at least one spring 446. Specifically, each lateral tube 32 of the seatback tube 30 is slidably sheathed with the sliding portion 444. The spring 446 is disposed between the sliding portion 444 and the seatback tube 30, for driving the lateral tube 32 to slide downward. Please refer to FIG. 10 to FIG. 14. FIG. 10 is a schematic drawing of the foldable stroller 1 with the seatback in a reclined position according to the embodiment of the present invention. FIG. 11 is a diagram of the rack 42 and the latching component 44 connected to the seatback tube 30 shown in FIG. 10 according to the embodiment of the present invention. FIG. 12 is a schematic drawing of the foldable stroller 1 with the seatback in an upright position according to the embodiment of the present invention. FIG. 13 is a diagram of the rack 42 and the latching component 44 connected to the seatback tube 30 shown in FIG. 12 according to the embodiment of the present invention. FIG. 14 is a diagram of the rack 42 and the latching component 44 connected to the seatback tube 30 shown in FIG. 7 according to the embodiment of the present invention. The sliding portion 444 includes an engaging part 4442 for selectively engaging with the first engaging slot 4282, the second engaging slot 4284, or the third engaging slots 4286 of engaging slots 428, so as to position the seatback tube 30. A shape of the operating portion 442 is similar to a shape of the seat tube 30, formed in a U-shape. The operating portion 442 includes two upright parts 4422 and a middle part 4424 connecting the two upright parts 4422. Two lower ends of the operating portion 442 extend outwardly to form bending parts 4426 substantially perpendicular to the upright parts 4422. The bending part 4426 is fixed to the corresponding sliding portion 444. Specifically, a lower end of the upright part 4422 is fixed to the engaging part 4442 of the sliding portion 444 via the bending part 4426, so as to realize an operation of the sliding portion 444 by the operating portion 442. That is, the operating portion 442 is pulled upwards to overcome an elastic force of the spring 446, so as to drive the sliding portion 444 to slide upwards, for separating the engaging part 4442 from the engaging slot 428.

As shown in FIG. 5 to FIG. 9, as the seatback is in the most reclined position, the seatback tube 30 and the seat rods 22 are substantially parallel, and the seatback tube 30 is in the most rear position. At this time, the engaging part 4442 of the latching component 44 engages with the first engaging slot 4282, the sliding portion 444 is located in a farther position away from the third shaft 156, and the spring 446 is compressed. For adjusting a reclined angle of the seatback, because the radii of the plurality of concentric arcs are decreasing from back to front, the seatback can be directly pushed to make the engaging part 4442 slide from the first concentric arc 4262 to the third concentric arc 4266 or the second concentric arc 4264. When the seatback is located in a desired position, the engaging part 4442 contacts against the corresponding engaging slot 428 for constraining the seatback tube 30 from rotating backwardly, without need to operate the operating portion 442 of the latching component 44.

Specifically, as the seatback is pushed, the engaging part 4442 slides with the seatback tube 30 along the concentric arcs about the third shaft 156, until the seatback tube 30 is located in a position shown in FIG. 10 and FIG. 11. At this time, the spring 446 drives the engaging part 4442 to contact against one of the third engaging slots 4286 to position the seatback and constrain the seatback tube 30 from rotating backwardly. As the seatback is pushed forward continuously to a position shown in FIG. 12 and FIG. 13, the seatback is in the most upright position, and the engaging part 4442 engages with the most front third engaging slot 4286. During the procedure of rotating the seatback from the most reclined position to the most upright position, the compression of the spring 446 is reducing, the friction is small, so that the seatback can be adjusted by pushing. The operation is easy and convenient. When it is desired to adjust the seatback from the most upright position to the most reclined position, it is needed to pull up the middle part 4424 of the operating portion 442. At this time, the bending part 4426 drives the sliding portion 444 fixed to the operating portion 442 to slide away from the third shaft 156, the spring 446 is compressed, and the engaging part 4442 separates from the engaging slot 428. As the seatback tube 30 is rotated backwardly to a desired position, the middle part 4424 of the operating portion 442 can be released, and the spring 446 drives the engaging part 4442 to engage with the engaging slot 428 again to position the seatback.

As mentioned above, the frame body 10 provides the convenience in the foldable stroller 1 to be stowed away while not in use or while being transported. The foldable stroller 1 further includes at least one linking component 50 connected between the seatback tube 30 and the frame body 10. The seatback tube 30 can rotate upwards automatically to reduce an occupied space of the foldable stroller 1 as folding the frame body 10 via the linking component 50 without operating the recline adjustment mechanism 40. Specifically, an end of the linking component 50 is connected to the lateral tube 32 of the seatback, and the other end of the linking component 50 is connected to the armrest 12. As the frame body 10 is folded, the armrest 12 rotates upwards relative to the push handle 14, and the linking component 50 connected to the armrest 12 can also be moved upwards, so as to pull the seatback tube 30 to rotate upwards.

When the seatback is adjusted from the most reclined position to the most upright position, the engaging part 4442 can easily slide from the concentric arc with a larger radius to the concentric arc with a smaller radius, without operating the operating portion 442. The second engaging slot 4284 and the most front third engaging slot 4286 have the concentric arcs with the same radius; therefore, the linking component 50 can drive the seatback tube 30 to rotate close to the push handle 14 easily no matter where the seatback is located, in the most reclined position or in the most upright position, so as to fold the seatback automatically. Specifically, as the foldable stroller 1 is folded, the seat rod 22 rotates about the third shaft 156 from a level position to an upright position, and the rack 42 connected to the seat rod 22 rotates from the position shown in FIG. 13 to the position shown in FIG. 14. As the seatback is located in the most upright position, the spring 446 is not compressed and does not provide an elastic force to the engaging part 4442. Therefore, rotation of the rack 42 can drive the engaging part 4442 from the most front third engaging slot 4286 to the second engaging slot 4284 almost frictionlessly, so as to fold the foldable stroller 1. As the seatback is located in the reclined position and the foldable stroller 1 is folded, the linking component 50 drives the seatback to the most upright position, and the spring 446 does not provide an elastic force to the engaging part 4442. Continuously the foldable stroller 1 is folded to rotate the rack 42, so that the engaging part 4442 moves from the most front third engaging slot 4286 to the second engaging slot 4284 almost frictionlessly, so as to accomplish folding the foldable stroller 1.

Specifically, the linking component 50 can be made of flexible material, such as fabric, an injection molded plastic, an elastic material, and so on. For unfolding the folded foldable stroller 1 shown in FIG. 7, the flexible linking component 50 does not interfere with adjustment of the reclined angle of the seatback. The seat rod 22 rotates from an upright position shown in FIG. 14 to a level position shown in FIG. 13 with the rack 42, and the armrest 12 connected to the linking component 50 rotates downward. The flexible linking component 50 does not apply any force to the seatback, so the seatback rotates about the third shaft 156 and the engaging part 4442 can move from the second engaging slot 4284 to the most front third engaging slot 4286 almost frictionlessly, so as to locate the seatback in the most upright position. After the seatback is located in the most upright position, the middle part 4424 of the operating portion 442 can be operated to adjust the reclined angle of the seatback as mentioned above. Hence, a further description is hereby omitted.

The linking component 50 is for driving the seatback tube 30 to rotate, so that the seatback tube 30 may be folded automatically. Various connecting location of the linking component 50 for achieving the above-mentioned function is within the scope of the present invention. For example, an end of the linking component 50 can be connected to the seatback tube 30, and the other end of the linking component 50 can be connected to an upper part of the front leg 11 or the rear leg 13. As the frame body 10 is folded, the armrest 12 rotates upwards relative to the push handle 14. At this time, the front leg 11 or the rear leg 13 pivoted on the armrest 12 also moves upwards, and the linking component 50 connected to the front leg 11 or the rear leg 13 pulls the seatback tube 30 to move upwards to be close to the push handle 14, so that the seatback may be folded automatically. Specifically, the foldable stroller 1 can include two linking components 50 respectively connected to the armrests 12 and the two lateral tubes 32 at left and right sides of the seatback tube 30.

In contrast with the prior art, the frame body of the present invention provides the convenience in the foldable stroller to be stowed away while not in use or while being transported. Furthermore, the recline adjustment mechanism disposed between the seatback and the seat can adjust the reclined angle of the seatback relative to the seat, so as to locate the seatback in the most upright position, the most reclined position, and any position therebetween, for providing users with more using conditions. Besides, the linking component connected between the seatback tube and the frame body can drive the seatback to rotate upwards without operating the recline adjustment mechanism again, so as to compact the foldable stroller as the frame body is folded. It has advantages of convenient operation and a simple structure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A foldable stroller comprising:
a frame body comprising a seat, a push handle disposed on two sides of the seat, an armrest, a front leg, a rear leg, and a seatback pivoted on the seat, an end of the armrest being pivoted on the push handle, the other end of the armrest being pivoted on the front leg and the rear leg, and the armrest, an upper portion of the front leg and an upper portion of the rear leg being formed as a lateral frame;
a recline adjustment mechanism fixed on the seat and connected to an end of the seatback for adjusting a reclined angle of the seatback; and
a linking component connected between the seatback and the lateral frame, the lateral frame rotating upwards relative to the push handle to move the linking component upwards, so as to drive the seatback to an upright position as folding the frame body.

2. The foldable stroller of claim 1, wherein the seatback is formed in a U-shape, the seatback comprises two lateral tubes connected to the recline adjustment mechanism, one end of the linking component is connected to the lateral tube, and the other end of the linking component is connected to the armrest.

3. The foldable stroller of claim 1, wherein a lower end of the push handle and the rear leg are pivotally connected via a rack shaft.

4. The foldable stroller of claim 1, wherein the linking component is made of flexible material.

5. The foldable stroller of claim 4, wherein the flexible material is fabric, an injection molded plastic, or an elastic material.

6. The foldable stroller of claim 1, wherein the recline adjustment mechanism comprises a rack fixed on the seat, and a latching component engaged with the rack and slidably connected to the end of the seatback.

7. The foldable stroller of claim 6, wherein the end of the seatback and the rack are pivotally connected.

8. The foldable stroller of claim 6, wherein the rack comprises a plurality of concentric arcs with different radii, the plurality of concentric arcs is stepped sequentially, and the radii of the plurality of concentric arcs are decreasing from back to front.

9. The foldable stroller of claim 6, wherein the latching component comprises a sliding portion slidably connected to the seatback, an operating portion connected to the sliding portion, and a latching portion disposed on the sliding portion for engaging with or separating from the rack.
